(19) United States
(12) Patent Application Publication
(10) Pub. No.: US 2021/0324668 A1
(43) Pub. Date: Oct. 21, 2021

(54) LOCKING MECHANISM WITH ADDITIONAL DAMPING MECHANISM

(71) Applicant: CELIKFORM GESTAMP OTOMOTIV ANONIM SIRKETI, Bursa (TR)

(72) Inventors: Fabio STRATICO, Nilufer/Bursa (TR); Erman ISIK, Nilufer/Bursa (TR); Ahmet BUTUN, Nilufer/Bursa (TR)

(73) Assignee: CELIKFORM GESTAMP OTOMOTIV ANONIM SIRKETI, Bursa (TR)

(21) Appl. No.: 17/273,169

(22) PCT Filed: Sep. 11, 2018
(86) PCT No.: PCT/TR2018/050477

§ 371 Date: Mar. 3, 2021

(30) Foreign Application Priority Data
Sep. 3, 2018 (TR) 2018/12542

(51) Int. Cl. E05C 17/60

(52) U.S. Cl. CPC E05C 17/60; B60J 5/062; E05Y 2201/218

(57) ABSTRACT

The present invention relates to a locking mechanism (1) with an additional damping mechanism (30) which provides opening/closing of the sliding door, provided in vehicles, by exerting less force and which provides protection of fixation resistance in open position even if it is positioned in the inclined position (II).

### TECHNICAL FIELD

The present invention relates to a locking mechanism with an additional damping mechanism which is active in case the vehicle is positioned at an inclined position and which increases the fixation resistance of the sliding door in the open position thereof.

### PRIOR ART

Sliding doors are used in various vehicles like passenger vehicles and big vehicles like minibus, autobus. Sliding doors provide various advantages for users. The most important advantages of sliding doors are that they are more usable when compared with classical doors and they need less force and they can be used for long time. Particularly in commercial vehicles, in some cases, the vehicle door shall stay open with full capacity. This process step cannot be provided in classical doors; and because of their various advantages like this, sliding doors are preferred in automotive sector. The realization of these actions is directly related to the locking mechanism used in sliding doors.

In the locking mechanisms used in the known state of the art, when the vehicle stops at an inclined position, the locking mechanisms may not be sufficient for keeping the door in the completely open position and the sliding door may easily pass to the closed position. This may lead to a danger for the passenger who gets on or who gets off the vehicle.

In literature, there is the patent application with title “Locking Apparatus for Sliding Door” and with application number US2018100335. In said application, a locking apparatus for sliding door is provided. The locking apparatus comprising a glass safety stopper and a hold-open lock striker sequentially provided in a vehicle body in an opening direction of the sliding door as it moves from a closed position to an open position. The locking apparatus further includes a window glass lever rotatably provided at the roller bracket, connected to a window glass provided at the sliding door via a first cable, and configured to interlock with the locking lever.

As a result, because of all of the abovementioned problems, an improvement is required in the related technical field.

### BRIEF DESCRIPTION OF THE INVENTION

The present invention relates to a locking mechanism, for eliminating the above mentioned disadvantages and for bringing new advantages to the related technical field.

The object of the present invention is to provide a locking mechanism which provides fixation of the sliding door, provided in vehicles, in the completely open position and which increases resistance of fixation of the sliding door in the open position particularly when the vehicle is positioned in the inclined position.

In order to realize all of the abovementioned objects and the objects which are to be deducted from the detailed description below, the present invention relates to a locking mechanism having a gripper where a pin, provided on the sliding door, is connected and a movable body whereon said gripper is positioned, a primary spring provided on said movable body and a piston in order to provide the additional force which will provide fixation/closing of the sliding door in the open position in an easier manner by exerting less force when the vehicle is positioned in a flat position and which will provide fixation of the sliding door in open position in a safe manner when the vehicle is positioned in an inclined position. Accordingly, the subject matter locking mechanism comprises at least one cover connected onto the movable body, an additional damping mechanism configured to slide with respect to said cover and to at least partially displace,

a primary compression extension provided on one of the cover and the additional damping mechanism and a secondary compression extension provided on the other one,

at least one secondary spring provided between the primary compression extension and the secondary compression extension,

at least one primary wall provided on the side of the movable body facing the additional damping mechanism and a secondary wall provided at a predetermined distance with respect to the primary wall and provided in a manner defining a lock housing in between,

a control element having a drive arm which can rotate at a first pin axis and provided at one side of the first pin and a control arm provided on the other side of the first pin,

at least one first press spring which forces the control element to rotate at the first pin axis and which compresses a ball inside a primary housing provided at the end side of the control arm or inside a secondary housing provided at the side of the control arm which is close to the first pin,

a locking element having a lock arm which can rotate at a second pin axis and which extends towards the area of the second pin which is in the vicinity of the drive arm,

at least one secondary press spring which tries to rotate the locking element at the second pin axis and which pushes the locking element towards the drive arm;

the subject matter locking mechanism is configured such that the secondary wall pushes the lock arm and the drive arm during sliding of the movable body and such that the ball displaces between the primary housing and the secondary housing in a free manner by means of releasing the ball by the control arm by means of pushing the drive arm,

when the ball arrives in the secondary housing, the drive arm pushes the lock arm towards the lock housing. Thus, when the vehicle is positioned in an inclined position, a locking mechanism is provided which increases fixation resistance of the sliding door in open position.

In a possible embodiment of the present invention, the control arm comprises a protrusion part between the primary housing and the secondary housing. Thus, the primary housing and the secondary housing are separated.

In a possible embodiment of the present invention, at least one movement cocoon is provided mutually on the movable body and the additional damping mechanism, and at least one delimiting extension is provided which extends inwards said movement cocoon. Thus, the movement distance of the additional damping mechanism is delimited together with the movable body.

In a possible embodiment of the present invention, in the additional damping mechanism, a movement surface is provided where a ball is positioned between the control arm and said movement surface and which has an inclined structure in a manner providing movement of the ball with respect to gravity. Thus, movement of the ball with respect to gravity is facilitated.

### BRIEF DESCRIPTION OF THE FIGURES

FIG. 1 is a representative perspective view of the assembled form of the subject matter locking mechanism.

FIG. 2 is a representative perspective view of the dismantled form of the subject matter locking mechanism.

FIG. 3 is a representative frontal cross sectional view of the assembled form of the subject matter locking mechanism.

FIG. 4 is a representative upper cross sectional view of the subject matter locking mechanism where the sliding door is in closed position and where the vehicle is stopped in inclined position.

FIG. 5 is a representative lateral cross sectional view of the subject matter locking mechanism where the sliding door is in closed position and where the vehicle is stopped in inclined position.

FIG. 6 is a representative top cross sectional view of the subject matter locking mechanism where the sliding door is in completely open position and where the vehicle is stopped in inclined position.

FIG. 7 is a representative lateral cross sectional view of the subject matter locking mechanism where the sliding door is in completely open position and where the vehicle is stopped in inclined position.

FIG. 8 is a representative upper cross sectional view of the subject matter locking mechanism where the sliding door passes to closing position and where the vehicle is stopped in inclined position.

FIG. 9 is a representative lateral cross sectional view of the subject matter locking mechanism where the sliding door passes to closing position and where the vehicle is stopped in inclined position.

FIG. 10 is a representative upper cross sectional view of the subject matter locking mechanism where the sliding door is in closed position and where the vehicle is stopped in inclined position.

FIG. 11 is a representative lateral cross sectional view of the subject matter locking mechanism where the sliding door is in closed position and where the vehicle is stopped in inclined position.

FIG. 12 is a representative top cross sectional view of the subject matter locking mechanism where the sliding door is in closed position and where the vehicle is stopped in flat position.

FIG. 13 is a representative lateral cross sectional view of the subject matter locking mechanism where the sliding door is in closed position and where the vehicle is stopped in flat position.

FIG. 14 is a representative top cross sectional view of the subject matter locking mechanism where the sliding door is in open position and where the vehicle is stopped in flat position.

FIG. 15 is a representative lateral cross sectional view of the subject matter locking mechanism where the sliding door is in open position and where the vehicle is stopped in flat position.

FIG. 16 is a representative upper cross sectional view of the subject matter locking mechanism where the sliding door is in closed position again and where the vehicle is stopped in flat position.

FIG. 17 is a representative lateral cross sectional view of the subject matter locking mechanism where the sliding door is in closed position again and where the vehicle is stopped in flat position.

### DETAILED DESCRIPTION OF THE INVENTION

In this detailed description, the subject matter locking mechanism (1) is explained with references to examples without forming any restrictive effect only in order to make the subject more understandable.

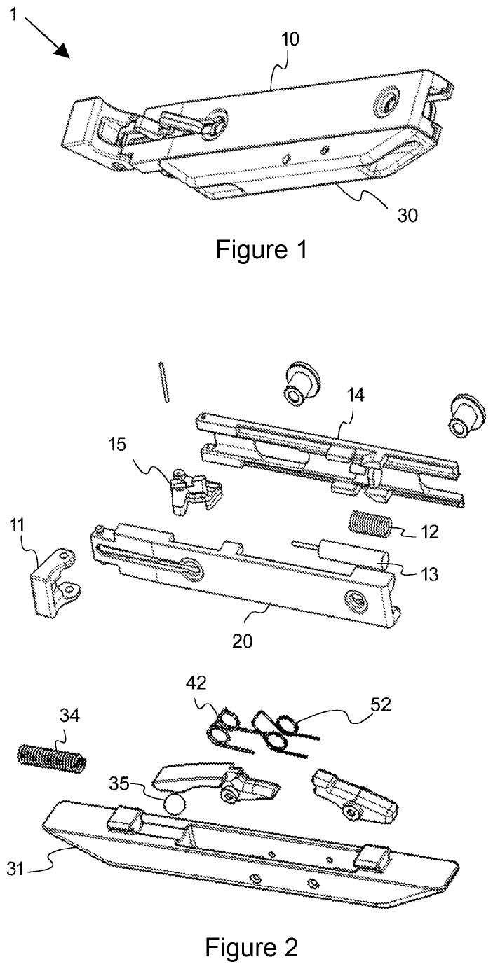

In FIG. 1, a representative perspective view of the assembled form of the subject matter locking mechanism (1) is given. The present invention relates to a locking mechanism (1) which provides additional force providing fixation of the sliding door in open position in a safe manner when the vehicle is positioned in an inclined position (II) and providing fixing/closing of the sliding door in open position with less force and in an easier manner when the vehicle is positioned in a flat position (I). In said locking mechanism (1), there is a primary damping mechanism (10) and an additional damping mechanism (30).

On said primary damping mechanism (10), there is a gripper (15) where a pin (60), provided on the sliding door, is connected. Said gripper (15) is connected onto a movable body (14). As can be seen in FIG. 2, there is a primary rail (12) and a piston (13) on said movable body (14). The movable body (14) is connected to a cover (20) in order to protect the inner section of the primary damping mechanism (10) from dust, dirt and similar items. A stopper (11) is connected to the end part of said cover in order to stop the movement of the pin (60), provided on the sliding door, after connection thereof to the gripper (15).

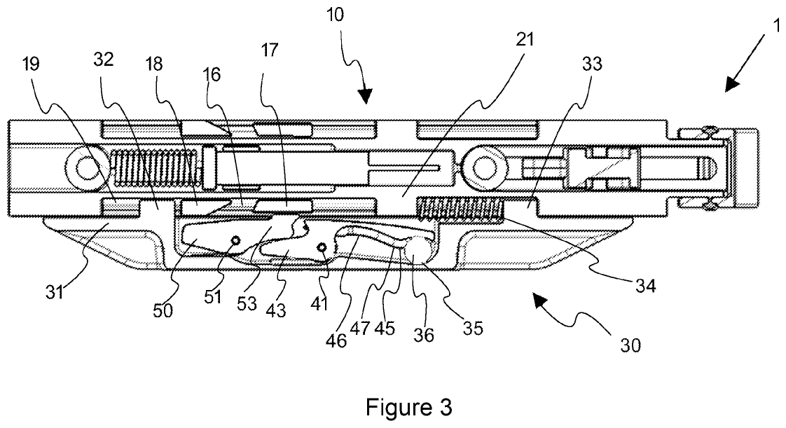

In FIG. 3, a representative frontal cross sectional view of the assembled form of the subject matter locking mechanism (1) is given. There is a secondary body (31) in said additional damping mechanism (30) configured to slide with respect to the cover (20) and to be able to displace at least partially. A secondary compression extension (33) is provided on said secondary body (31). At least one secondary spring (34) is positioned between a primary compression extension (21), provided on the side of the cover (20) facing the additional damping mechanism (30), and said second compression extension. There is at least one movement cocoon (19) provided mutually on the movable body (14) and the additional damping mechanism (30) and there is at least one delimiting extension (32) extending into said movement cocoon (19) through the additional damping mechanism (30). Thanks to said delimiting extension (32), the movement of the additional damping mechanism (30), which can displace with respect to the cover (60), is delimited. There is at least one primary wall (17) and a secondary wall (18) provided on the side of the movable body (14) facing the additional damping mechanism (30). A lock housing (16) is provided such that there is a predetermined distance between said primary wall (17) and said secondary wall (18).

In the additional damping mechanism (30), there is a drive arm (43) which can rotate at a first pin (41) axis and provided on one side of said first pin (41) and there is a control element (40) having a control arm (44) provided on the other side thereof. On said control arm (44), there is a secondary housing (46) provided on the side which is close to the first pin (41) and there is a primary housing (45) provided at the end side of the control arm (44). There is a protrusion part (47) between said secondary housing (46) and said primary housing (45). In the additional damping mechanism (30), on the surface provided against the control arm (44), there is a movement surface (35) in a manner providing inclination. A ball (36) is positioned between said movement surface (35) and said control arm (44). The inclination height in the movement surface (35) decreases towards the primary housing (45) and it provides positioning of said ball (36) inside the primary housing (45) under normal conditions depending on gravity. In the control element (40), moreover, there is at least one primary press spring (42) which forces the control element (40) to rotate at the first pin (41) axis and which compresses the ball (36) inside the primary housing (45) or inside the secondary housing (46).

In the additional damping mechanism (30), there is a locking element (50) which can rotate at a second pin (51) axis and having a lock arm (53) which extends towards the drive arm (43) vicinity of the second pin (51). At the locking element (50), there is at least one secondary press spring (52) which provides rotation of the lock arm (53) at the second pin (51) axis.

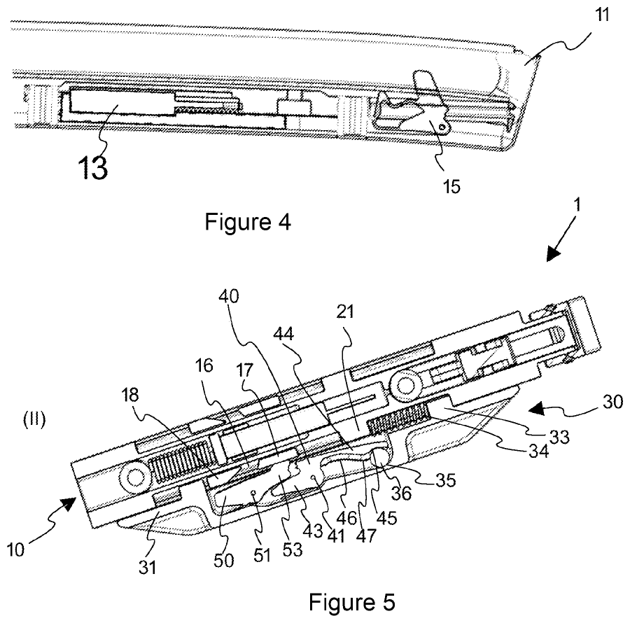

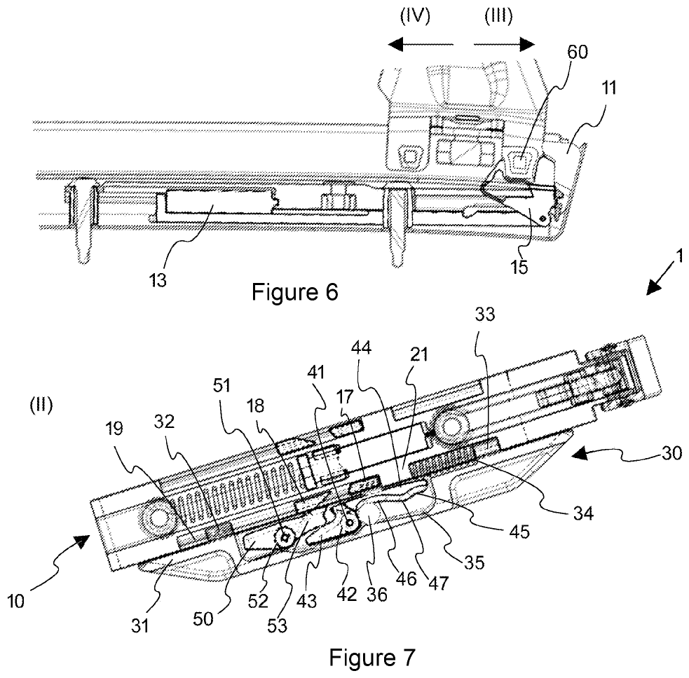

In FIGS. 4 and 5, the representative upper and lateral cross sectional views of the subject matter locking mechanism (1) where the sliding door is in closed position and where the vehicle is stopped in inclined position (II) are given. When the vehicle stops in inclined position (II) and when the sliding door is in closed position, the ball (36), provided in the additional damping mechanism (30), is positioned in the primary housing (45). As can be seen in FIGS. 6 and 7, when the sliding door advances at an opening direction (III), the pin (60) provided on the sliding door engages into the gripper (15) and pushes the movable body (14) in the stopper (11) direction. In this case, the secondary wall (18), provided on the movable body (14), pushes the lock arm (53), provided in the additional damping mechanism (30), towards the drive arm (43). As the drive arm (43) is pushed, the ball (36) positioned in the primary housing (45) in the control arm (44) is released and the ball (36) is positioned inside the secondary housing (46) after sliding on the movement surface (35) as a result of gravity effect in this case. When the ball (36) arrives in the secondary housing (46), since the primary housing (45) is empty, the drive arm (43) begins pushing the lock arm (53).

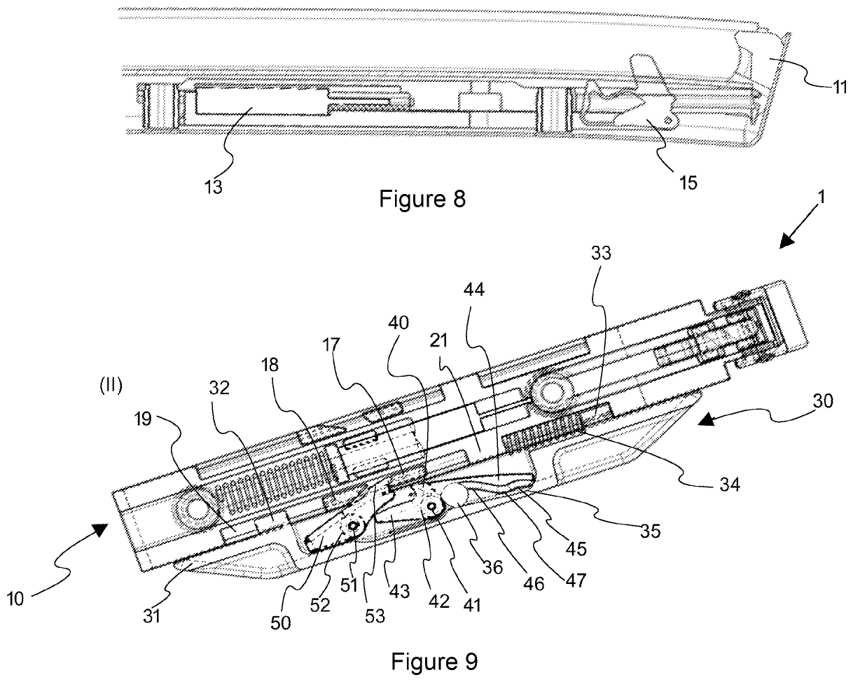

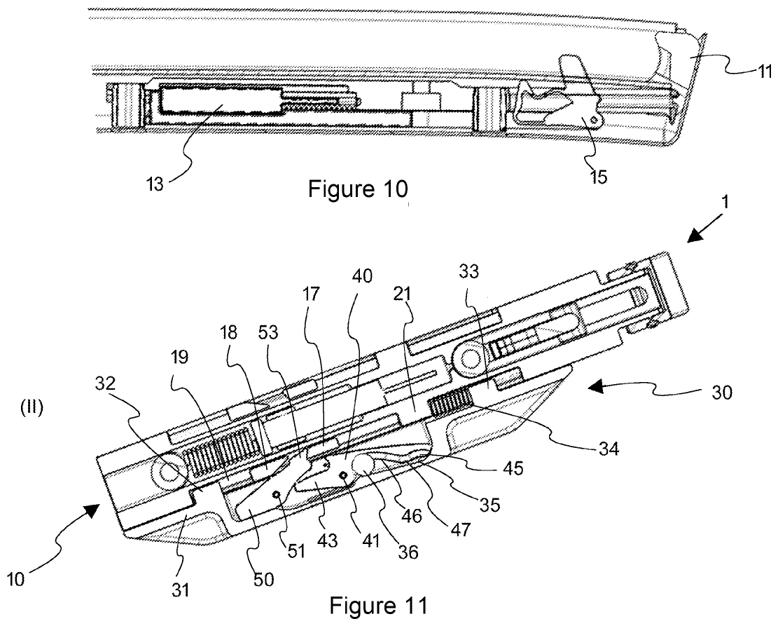

In FIGS. 8 and 9, the representative upper and lateral cross sectional views of the subject matter locking mechanism (1) where the sliding door passes to closing position and where the vehicle is stopped in inclined position (II) are given. When the sliding door advances at a closing direction (IV), the movable body (14) moves in the closing direction (IV). By means of the movement of the movable body (14) in the closing direction (IV), the lock arm (53), pushed by the drive arm (43), enters into the lock housing (16) provided between the primary wall (17) and the secondary wall (18). The secondary spring (34) is activated as the lock arm (53) enters into the lock housing (16). As can be seen in FIG. 11, in this case, the secondary compression extension (33), provided in the secondary body (31), compresses the secondary spring (34) and the additional damping mechanism (30) begins advancing in the closing direction (IV). The additional damping mechanism (30) can move along the width of the movement cocoon (19). Thus, in the inclined position (II), the closing resistance of the door is increased.

The return of the additional damping mechanism (30) back to the prior position is provided in the case where the closed door again passes to open position. As the sliding door is opened, the movable body (14) advances in the opening direction (III) and the secondary wall (18) again pushes the lock arm (53) onto the drive arm (43). In this case, the ball (36) is released and it can move on the movement surface (35) thanks to the effect of gravity.

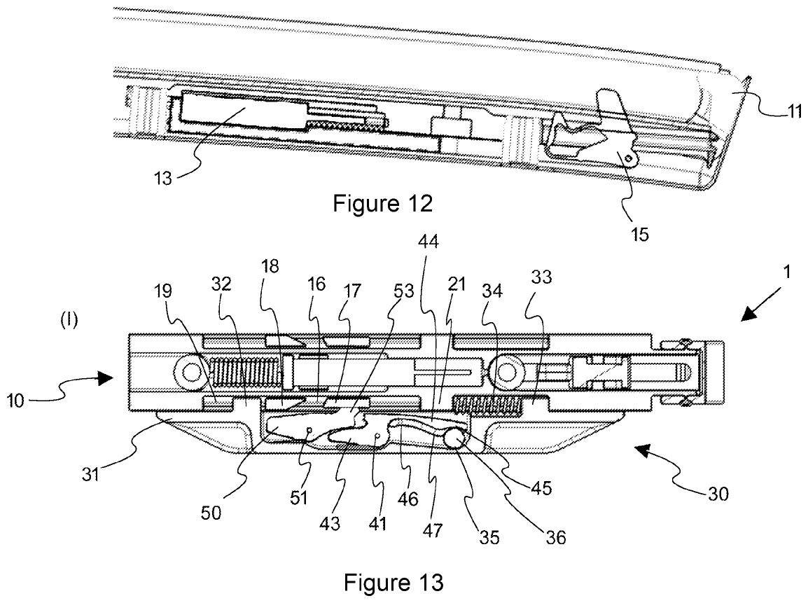

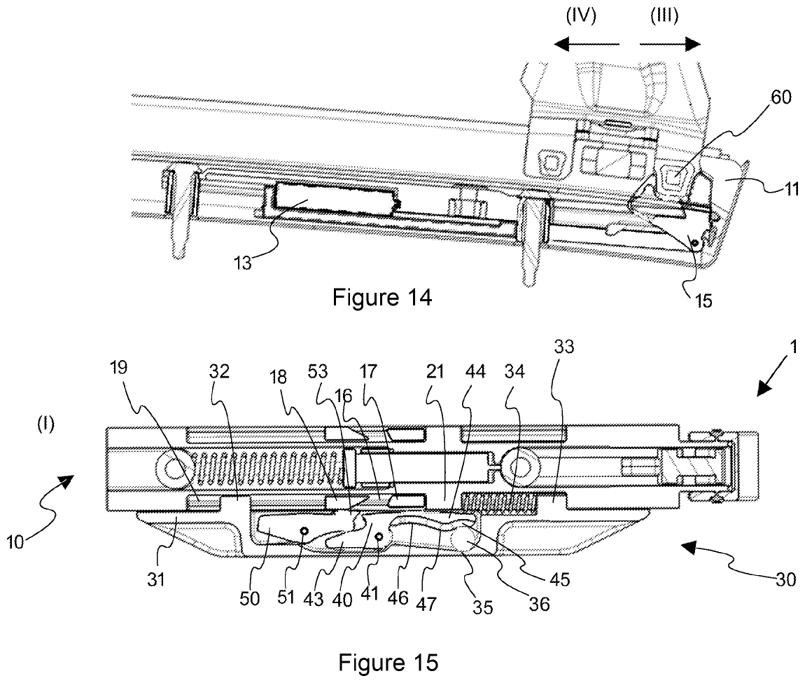

In FIGS. 12 and 13, the representative top and lateral cross sectional views of the subject matter locking mechanism (1) where the sliding door is in closed position and where the vehicle is stopped in flat position (I) are given. While the vehicle is in flat position (I), when the sliding door is in closed position, the ball (36) is positioned on the primary housing (45). As can be seen in FIG. 15, when the sliding door moves in the opening direction (III), the pin (60) enters into the gripper (15) and provides the movable body (14) to advance in the opening direction (III). As the movable body (14) advances in the opening direction (III), the secondary wall (18) pushes the lock arm (53) and the lock arm (53) exerts pressure to the drive arm (43). As the drive arm (43) is pushed by the lock arm (53), the control arm (44) moves upwardly. In this case, since the vehicle is in flat position (I), the ball (36) continues to stay in the primary housing (45).

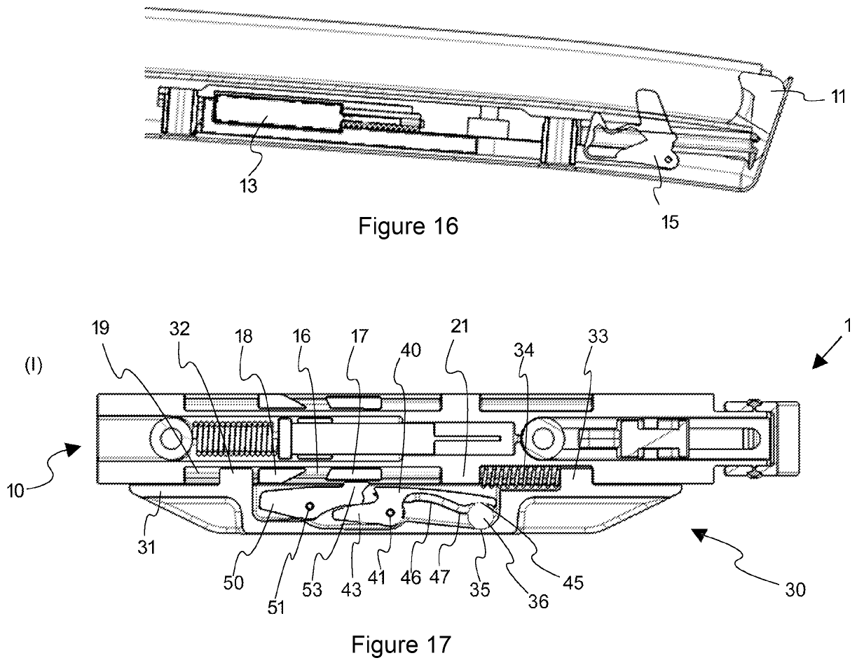

In FIGS. 16 and 17, the representative upper and lateral cross sectional views of the subject matter locking mechanism (1) where the sliding door is in closed position again and where the vehicle is stopped in flat position (I) are given. In case the sliding door moves in the closing direction (IV), the primary spring (12) is compressed by means of the piston (13) and the movable body (14) moves in the closing direction (IV). During the movement of the movable body (14) in the closing direction (IV), since the ball (36) is positioned in the primary housing (45), the control arm (44) cannot move. Since the control arm (44) cannot move, the drive arm (43) does not push the lock arm (53). Therefore, in case the vehicle is in flat position (I), the additional damping mechanism (30) is not active.

Thus, a locking mechanism (1) having an additional damping mechanism (30) is provided which is active and which increases the fixation resistance of the sliding door in the open position in case the vehicle is positioned at an inclined position (II) and which is deactivated in case the vehicle is positioned in flat position (I).

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

1 Locking mechanism
10 Primary damping mechanism
11 Stopper
12 Primary spring
13 Piston
14 Movable body
15 Gripper
16 Lock housing
17 Primary wall
18 Secondary wall
19 Movement cocoon
20 Cover
21 Primary compression extension
30 Additional damping mechanism
31 Secondary body
32 Delimiting extension
33 Secondary compression extension
34 Secondary spring
35 Movement surface
36 Ball
40 Control element
41 First pin
42 Primary press spring
43 Drive arm
44 Control arm
45 Primary housing
46 Secondary housing
47 Protrusion part
50 Locking element
51 Second pin
52 Secondary press spring
53 Lock arm
60 Pin
(I) Flat position
(II) Inclined position
(III) Opening direction
(IV) Closing direction

1. A locking mechanism having a gripper where a pin, provided on the sliding door, is connected and a movable body whereon said gripper is positioned, a primary spring provided on said movable body and a piston in order to provide the additional force which will provide fixation/closing of the sliding door in the open position in an easier manner by exerting less force when the vehicle is positioned at a flat position and which will provide fixation of the sliding door in open position in a safe manner when the vehicle is positioned in an inclined position, wherein comprising at least one cover connected onto the movable body, an additional damping mechanism configured to slide with respect to said cover and to at least partially displace, a primary compression extension provided on one of the cover and the additional damping mechanism and a secondary compression extension provided on the other one, at least one secondary spring provided between the primary compression extension and the secondary compression extension, at least one primary wall provided on the side of the movable body facing the additional damping mechanism and a secondary wall provided at a predetermined distance with respect to the primary wall and provided in a manner defining a lock housing in between, a control element having a drive arm which can rotate at a first pin axis and provided at one side of the first pin and a control arm provided on the other side of the first pin, at least one first press spring which forces the control element to rotate at the first pin axis and which compresses a ball inside a primary housing provided at the end side of the control arm or inside a secondary housing provided at the side of the control arm which is close to the first pin,
a locking element having a lock arm which can rotate at a second pin axis and which extends towards the area of the second pin which is in the vicinity of the drive arm,
at least one secondary press spring which tries to rotate the locking element at the second pin axis and which pushes the locking element towards the drive arm;
the subject matter locking mechanism is configured such that the secondary wall pushes the lock arm and the drive arm during sliding of the movable body and such that the ball displaces between the primary housing and the secondary housing in a free manner by means of releasing the ball by the control arm by means of pushing the drive arm,
when the ball arrives in the secondary housing, the drive arm pushes the lock arm towards the lock housing.

2. A locking mechanism according to claim 1, wherein the control arm comprises a protrusion part between the primary housing and the secondary housing.

3. A locking mechanism according to claim 1, wherein at least one movement cocoon is provided mutually on the movable body and the additional damping mechanism, and at least one delimiting extension is provided which extends inwards said movement cocoon.

4. A locking mechanism according to claim 1, wherein in the additional damping mechanism, a movement surface is provided where a ball is positioned between the control arm and said movement surface and which has an inclined structure in a manner providing movement of the ball with respect to gravity.
